(19) United States
(12) Patent Application Publication
(10) Pub. No.: US 2024/0362721 A1
(43) Pub. Date: Oct. 31, 2024

(54) JOURNAL ENTRY PARSING

(71) Applicant: PwC Product Sales LLC, New York, NY (US)

(72) Inventors: Alexander Orlando DELGADO, Tampa, FL (US); Jason Matthew BOLTZ, Tampa, FL (US)

(73) Assignee: PwC Product Sales LLC, New York, NY (US)

(21) Appl. No.: 18/308,339

(22) Filed: Apr. 27, 2023

(51) Int. Cl. G06Q 40/12

(52) U.S. Cl. CPC G06Q 40/12

(57) ABSTRACT

A system for parsing journal entries is configured to receive input data comprising a plurality of journal entries from one or more data sources and consecutively parse each respective journal entry. The journal entries can be parsed according to an algorithm that selects subsets of either credit or debit records from the journal entry, identifies matching subsets of records that foot to zero when combined with the selected records, and removes subsets containing records in the matching subsets from respective credit and debit data structures.

### FIELD

This disclosure relates generally to financial reporting and more specifically to systems and methods for isolation of smaller journal entries from within larger journal entries.

### BACKGROUND

In financial reporting, and specifically in auditing of financial data, auditors often “parse” journal entries, or identify financial statement line items (e.g., debit records and credit records) that form a sub-journal entry within a larger entry that foot to zero. Existing approaches for parsing large journal entries in financial reporting rely on either obtaining information about the journal entries (e.g., which credit and debit records form a single journal entry) from the auditee or “brute force” computation of every possible combination until a combination that foots to zero is found. Such brute force methods can become computationally unworkable as the number of possible combinations grows exponentially with the number of line items in a journal entry. Even for a relatively average journal entry size of, for instance, thirty entries, there are over one billion possible combinations of debit records and credit records. As such, when an engagement team is auditing a client's financials, batch journal entries that contain hundreds or thousands of line items can be almost impossible to make sense of when there is no direct link between which debit records go with which credit records. As such, there is a need for an agnostic method (i.e., a method which does not rely on prior knowledge) for parsing journal entries that is not rendered inoperable by limitations on computation.

### SUMMARY

Disclosed herein are systems, apparatuses, devices, methods, and non-transitory storage media for parsing journal entries. The systems and methods disclosed herein are configured to isolate and remove “sub-journal entries” from larger journal entries. A “sub-journal entry” can include a subset of debit records and a subset of credit records within a larger journal entry that when combined together foot to zero (i.e., the sum of each of the credit records and each of the debit records in the sub-journal entry is equal to zero). The systems, apparatuses, devices, methods and non-transitory storage media disclosed herein can exponentially reduce the number of combinations of debit records and credit records in a journal entry by identifying viable sub-journal entries (e.g., those that foot to zero) and removing the credit records and debit records included in those sub-journal entries from the combinatorial space. Removing such records from consideration substantially increases the efficiency of journal entry parsing in financial auditing without prior knowledge related to the how the journal entries can or should be parsed.

According to an aspect, a method for parsing journal entries includes selecting a subset of debit records or a subset of credit records from input data (e.g., from general ledger data). It should be understood that unless otherwise indicated throughout “subset” may refer to as few as a single credit or debit record from a journal entry in the input data, or a combination of debit or credit records that may include as many as all of the debit records or credit records from a journal entry in the input data. In accordance with selection of a subset that includes only debit records, a system performing the exemplary method for parsing journal entries will determine whether a corresponding subset of credit records (e.g., a subset of credit records that would foot to zero when combined with the selected subset of debit records) exists in a data structure comprising one or more subsets of credit records.

If the system performing the method for parsing journal entries determines that there is a matching subset of credit records in the data structure comprising one or more subsets of credit records, the system will record the matching combination of the subset of credit records and subset of debit records as a sub-journal entry (e.g., in a data structure for storing sub-journal entries). The system will further remove (1) all subsets of debit records that include one or more of the debit records (e.g., debit line items) included in the sub-journal entry from a data structure comprising one or more subsets of debit records and (2) all subsets of credit records that include one or more of the credit records (e.g., credit line items) included in the sub-journal entry from the data structure comprising one or more subsets of credit records. Alternatively, if there is no matching subset of credit records in the data structure comprising one or more subsets of credit records, the system will add the subset of debit records to the data structure comprising one or more subsets of debit records.

The system will perform substantially the same steps described above if the selected subset includes only credit records (i.e., the system will search for a matching subset of debit records in a data structure comprising one or more subsets of debit records and if there is a match, it will identify the matching subsets as a sub-journal entry and remove the appropriate subsets from each data structure). After either identifying a sub-journal entry or adding the selected subset to the proper data structure as described above, the system may repeat the process described above until there are no remaining subsets of debit records or credit records to process.

An exemplary method for parsing journal entries includes: receiving input data comprising a plurality of journal entries from one or more data sources; and parsing a first journal entry of the plurality of journal entries, wherein parsing the first journal entry comprises: (a) selecting a first subset of records from a first journal entry of the plurality of journal entries, the first subset of records comprising either one or more debit records or one or more credit records; (b) determining that an identifier associated with the first subset of records matches an identifier associated with a second subset of records, the second subset of records comprising one or more credit records if the first subset of records comprises one or more debit records and the second subset of records comprising one or more debit records if the first subset of records comprises one or more credit records; and (c) in accordance with determining that the identifier associated with the first subset of records matches the identifier associated with the second subset of records, recording the first subset of records and second subset of records as a first sub-journal entry.

In some examples, the method for parsing journal entries includes: in accordance with determining that additional subsets of records remain in the first journal entry, repeating steps (a) through (c).

In some examples, the method for parsing journal entries includes: in accordance with determining that the identifier associated with the first subset of records matches the identifier associated with the second subset of records: identifying one or more subsets of records comprising debit records in the first sub-journal entry in a first data structure; and removing the identified one or more subsets of records from the first data structure.

In some examples, the method for parsing journal entries includes: in accordance with determining that the identifier associated with the first subset of records matches the identifier associated with the second subset of records: identifying one or more subsets of records comprising credit records in the first sub-journal entry in a second data structure; and removing the identified one or more subsets of records from the second data structure.

In some examples of the method for parsing journal entries, the first data structure comprises a first hash table comprising one or more subsets of debit records from the first journal entry, and wherein the first hash table does not include credit records.

In some examples of the method for parsing journal entries, the second data structure comprises a second hash table comprising one or more subsets of credit records from the first journal entry, and wherein the second hash table does not include debit records.

In some examples, the method for parsing journal entries includes: in accordance with determining that an identifier associated with the first subset of records does not match an identifier associated with a second subset of records, adding the first subset of records to the first data structure if the first subset of records comprises debit records and adding the first subset of records to the second data structure if the first subset of records comprises credit records.

In some examples of the method for parsing journal entries, the input data comprises general ledger data.

In some examples, the method for parsing journal entries includes: generating an output, the output comprising an indication of the debit records and credit records forming the sub-journal entry.

In some examples of the method for parsing journal entries, the output comprises any one or more of: an indication of a misstatement, an indication of a high-risk transaction, indications of inefficiencies in business operations, indications of errors in financial reporting, duplication of financial transactions, identification and grouping of similar transactions, indications distinguishing between financial events booked together, identifications of applicable offsets to transactions, and assessments of the validity of offsets to a transaction.

In some examples of the method for parsing journal entries, the first and second identifier are generated using a hash function.

In some examples of the method for parsing journal entries, the first identifier comprises an absolute value of the first subset of records and the second identifier comprises an absolute value of the second subset of records.

An exemplary system for parsing journal entries includes one or more processors configured to cause the system to: receive input data comprising a plurality of journal entries from one or more data sources; and parse a first journal entry of the plurality of journal entries, wherein parsing the first journal entry comprises: (a) selecting a first subset of records from a first journal entry of the plurality of journal entries, the first subset of records comprising either one or more debit records or one or more credit records; (b) determining that an identifier associated with the first subset of records matches an identifier associated with a second subset of records, the second subset of records comprising one or more credit records if the first subset of records comprises one or more debit records and the second subset of records comprising one or more debit records if the first subset of records comprises one or more credit records; and (c) in accordance with determining that the identifier associated with the first subset of records matches the identifier associated with the second subset of records, recording the first subset of records and second subset of records as a first sub-journal entry.

An exemplary non-transitory computer readable storage medium stores one or more programs for parsing journal entries, the one or more programs configured to be executed by one or more processors of an electronic device that when executed by the device cause the device to: receive input data comprising a plurality of journal entries from one or more data sources; and parse a first journal entry of the plurality of journal entries, wherein parsing the first journal entry comprises: (a) selecting a first subset of records from a first journal entry of the plurality of journal entries, the first subset of records comprising either one or more debit records or one or more credit records; (b) determining that an identifier associated with the first subset of records matches an identifier associated with a second subset of records, the second subset of records comprising one or more credit records if the first subset of records comprises one or more debit records and the second subset of records comprising one or more debit records if the first subset of records comprises one or more credit records; and (c) in accordance with determining that the identifier associated with the first subset of records matches the identifier associated with the second subset of records, recording the first subset of records and second subset of records as a first sub-journal entry.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

FIG. 1 illustrates an exemplary system architecture according to one or more embodiments.

FIG. 2 illustrates an exemplary method for parsing journal entries according to one or more embodiments.

FIG. 3 illustrates an exemplary data structure including a credit hash table and debit hash table according to one or more embodiments.

FIG. 4 illustrates exemplary outputs of a method for parsing journal entries according to one or more embodiments.

FIG. 5 illustrates an exemplary computing system according to one or more embodiments.

### DETAILED DESCRIPTION

Disclosed herein are systems, apparatuses, devices, methods, and non-transitory storage media for parsing journal entries. The systems and methods disclosed herein are configured to isolate and remove “sub-journal entries” from larger journal entries. A “sub-journal entry” can include a subset of debit records and a subset of credit records within a larger journal entry that when combined together foot to zero (i.e., the sum of each of the credit records and each of the debit records in the sub-journal entry is equal to zero). The systems, apparatuses, devices, methods and non-transitory storage media disclosed herein can exponentially reduce the number of combinations of debit records and credit records in a journal entry by identifying viable sub-journal entries (e.g., those that foot to zero) and removing the credit records and debit records included in those sub-journal entries from the combinatorial space. Removing such records from consideration substantially increases the efficiency of journal entry parsing in financial auditing without prior knowledge related to the how the journal entries can or should be parsed.

According to an aspect, a method for parsing journal entries includes selecting a subset of debit records or a subset of credit records from input data (e.g., from general ledger data). It should be understood that unless otherwise indicated throughout “subset” may refer to as few as a single credit or debit record from a journal entry in the input data, or a combination of debit or credit records that may include as many as all of the debit records or credit records from a journal entry in the input data. In accordance with selection of a subset that includes only debit records, a system performing the exemplary method for parsing journal entries will determine whether a corresponding subset of credit records (e.g., a subset of credit records that would foot to zero when combined with the selected subset of debit records) exists in a data structure comprising one or more subsets of credit records.

If the system performing the method for parsing journal entries determines that there is a matching subset of credit records in the data structure comprising one or more subsets of credit records, the system will record the matching combination of the subset of credit records and subset of debit records as a sub-journal entry (e.g., in a data structure for storing sub-journal entries). The system will further remove (1) all subsets of debit records that include one or more of the debit records (e.g., debit line items) included in the sub-journal entry from a data structure comprising one or more subsets of debit records and (2) all subsets of credit records that include one or more of the credit records (e.g., credit line items) included in the sub-journal entry from the data structure comprising one or more subsets of credit records. Alternatively, if there is no matching subset of credit records in the data structure comprising one or more subsets of credit records, the system will add the subset of debit records to the data structure comprising one or more subsets of debit records.

The system will perform substantially the same steps described above is the selected subset includes only credit records (i.e., the system will search for a matching subset of debit records in a data structure comprising one or more subsets of debit records and if there is a match, it will identify the matching subsets as a sub-journal entry and remove the appropriate subsets from each data structure). After either identifying a sub-journal entry or adding the selected subset to the proper data structure as described above, the system may repeat the process described above until there are no remaining subsets of debit records or credit records to process.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are accorded the scope consistent with the claims.

### Exemplary System for Parsing Journal Entries

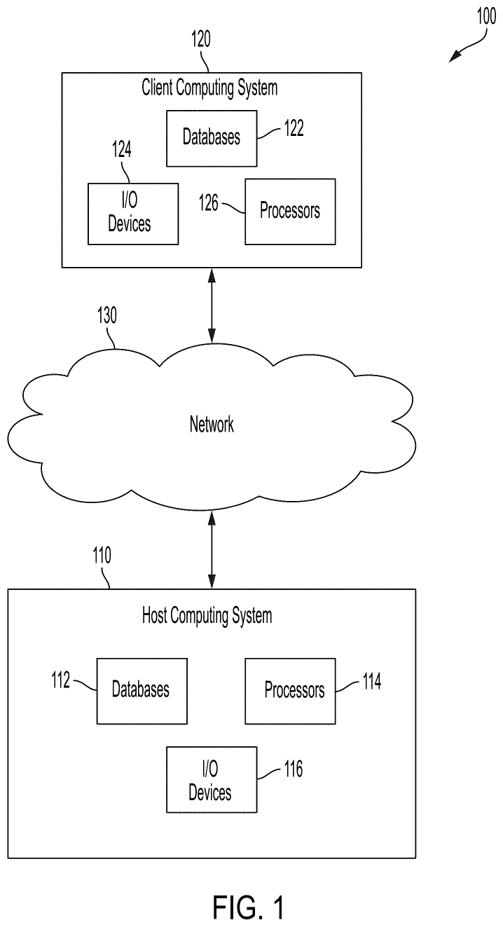

FIG. 1 illustrates an exemplary system 100 for parsing journal entries. The system 100 may include a host computing system 102. The host computing system 102 may include one or more databases 112, one or more processors 114, and one or more input/output (I/O) devices 116. The host computing system may be communicatively coupled to a client computing system 120 via network 130. The network 130 may include one or more wired or wireless communication protocols or interfaces for communicatively coupling the host computing system 110 to the client computing system 120. Like the host computing system 110, the client computing system 120 may include one or more databases 122, one or more I/O devices 124, and one or more processors 126.

The client computing system databases 122 may include general ledger data associated with an enterprise's financial data. General ledger data includes a plurality of journal entries. Journal entries include at least one debit record and at least one credit record, but a single journal entry may include any number of debit records and credit records. A journal entry including more than one debit record and one credit record is known as a compound journal entry. Compound journal entries may include a plurality of sub-journal entries, which are subsets of corresponding debit records and credit records that foot (i.e., sum) to zero within the larger compound journal entry.

The one or more processors 114 of the host computing system 110 may be configured to receive data from the client computing system 120. In some examples, the data may be transmitted via network 130 from the client computing system 120 to the host computing system 110. The data received by the one or more processors 114 of the host computing system 110 may include the aforementioned general ledger data, and as such the received data may be separated into a collection of debits records and credit records. The received data may further be separated into distinct journal entries (e.g., the data received may include a plurality of individual journal entries delineated from each of the other journal entries in the received data, and each journal entry may include any number of debit records and credit records forming the journal entry).

Upon receipt of the general ledger data, the one or more processors 114 of the host computing system 110 can be configured to parse the journal entries (e.g., by identifying sub-journal entries forming portions of the respective journal entries in the general ledger data and removing the credit and debit records associated with the identified sub-journal entries from the combinatorial space, as described further throughout). The one or more processors 114 may parse the journal entries included in the received general ledger data by continuously constructing distinct data structures, a first data structure comprising subsets of debit records and a second data structure comprising subsets of credit records, comparing identifiers (e.g., hashes when the data structure is a hash table, or sums of the debits or credits in a subset when the data structure is an array) associated with subsets of debit records from the first data structure and identifiers associated with subsets of credit records from the second data structure to identify matching subsets, and removing all subsets that include the debit or credit records included in the matching subsets from the respective data structures.

For instance, a more concrete example of parsing a journal entry, by the one or more processors 114, may proceed as follows. The one or more processors 114 of the host system may be configured to select a subset of records from a first journal entry and determine whether the subset of records is a subset of credit records or debit records. The one or more processors may be configured to select subsets from separate data populations, each population including either debit records or credit records, or may be configured to determine that a subset includes only one of either debit records or credit records prior to selecting or during selection of the subset based upon a flag/label in the data. According to a determination that the subset of records is a subset of debit records, the one or more processors 114 will process the subset of records as debit records, and alternatively, according to a determination that the subset of records is a subset of credit records, the one or more processors 114 will process the subset of records as credit records.

Upon determining that the subset of records is a subset of debit records, the one or more processors 114 may be configured to assign an identifier to the first subset of debit records. The identifier may be generated using a hash function. The identifier may be a hash of a sum of the debit records in the debit subset (or credit records in the credit subset if a credit subset were selected). The identifier may be the sum of the debit records in the debit subset (or credit records in a credit subset if a credit subset were selected). The identifier may be an absolute value of the one or more debit records in the first subset of debit records (or credit records in a credit subset if a credit subset were selected). The identifier can indicate the amount of money that is relevant to the selection. For instance, if two credits are selected as a subset, and their amounts are $5.50 and $10.20, the identifier is the sum of the selection, $15.70. This identifier can then be represented as an integer, a float, a decimal, or a combination of these data types.

The one or more processors 114 may then be configured to search a data structure comprising a population of subsets of credit records to attempt to identify a matching identifier associated with a subset of credit records. The data structure comprising the population of subsets of credit records may be a hash table comprising one or more subsets of credit records from the first journal entry (the “credit hash table”). The one or more subsets of credit records from the first journal entry in the credit hash table may each be associated with identifiers in the credit hash table.

In the event that the one or more processors 114 identify a matching identifier associated with a subset of credit records in the data structure, the processors 114 may be configured to record the subset of debit records and the corresponding subset of credit records as a sub-journal entry in a data log, for instance in one of the databases 112 of host computing system 110. After recording the subset of debit records and the corresponding subset of credit records as a sub-journal entry in a data log, the one or more processors 114 may be configured to remove one or more subsets of credit records from a data structure. The one or more processors 114 may remove, from the data structure comprising the population of subsets of credit records from the first journal entry, all subsets of credit records that include one or more of the credit records in the subset of credit records that was identified as matching the selected subset of debit records. The one or more processors 114 may further be configured to remove from a separate data structure comprising a population of subsets of debit records from the first journal entry, all subsets of debit records that include one or more of the debit records in the selected subset of debit records.

The one or more processors 114 may be configured to iteratively select subsets of credit or debit records from the first journal entry, identify matching subsets of records in the appropriate data structure (e.g., in a data structure comprising subsets of debit records if the selected subset comprises credit records, and in a data structure comprising subsets of credit records if the selected subset comprises debit records), and remove subsets of records that include any of the debit or credit records in the matching subsets from a respective debit data structure and credit data structure.

As noted above, in some examples the data structures (the debit data structure and credit data structure) may be hash tables. However, other data structures can be used. For instance, alternative data structures include, but are not limited to, hash sets, b-trees, sorted arrays, and unsorted arrays. Hash tables, hash sets, and b-trees are similar to one another and are optimized for quick lookups. Sorted arrays allow for binary searches on data for efficient lookup. Unsorted arrays are also feasible but may be slower compared to other options. Different identifier types may be used for subsets of credit and debit records in the respective data structures depending on the type of data structure implemented. For instance, hashes can be used by hash tables, hash sets, and b-trees. Arrays can use the sum of the debit subset or the sum of the credit subset as the identifier.

The one or more processors 114 may further be configured to generate one or more outputs. The outputs may include indications of anomalous journal entries and/or sub-journal entries. The indications of anomalous journal entries or sub-journal entries can include an indication of misstatements or high-risk transactions. The output may include any one or more of the following: indications of inefficiencies in business operations, indications of errors in financial reporting, duplication of financial transactions, identification and grouping of similar transactions, indications distinguishing between financial events booked together, identifications of applicable offsets to transactions, and/or assessments of the validity of offsets to a transaction.

### Exemplary Method for Parsing Journal Entries

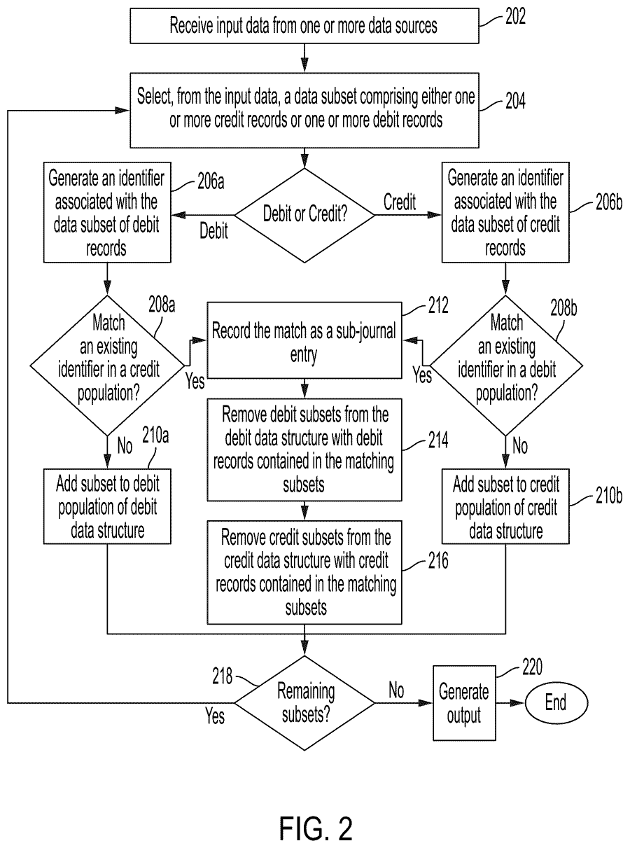

FIG. 2 illustrates an exemplary method 200 for parsing journal entries according to some embodiments. The following steps of the method 200 may be performed by one or more processors of a system configured to carry out the method 200. For instance, the method 200 may be performed using the system 100 described above with reference to FIG. 1.

In some examples, the method 200 can begin at step 202. Step 202 can include receiving input data from one or more data sources. The input data received at step 202 may include general ledger data, which may include a plurality of journal entries. As described above, a journal entry includes at least one debit record and at least one credit record, but a single journal entry may include any number of debit records and credit records. A journal entry including more than one debit record and one credit record is known as a compound journal entry. Compound journal entries may include a plurality of sub-journal entries, which are subsets of corresponding debit records and credit records that foot (e.g., sum) to zero within the larger compound journal entry.

The input data received at step 202 may be received by one or more processors configured to parse journal entries included in the input data. The input data may include additional information to the credit and debit records in the general ledger data. For instance, the input data may also include account numbers, account descriptions, timestamps, or other ancillary data associated with the debit and credit records in the general ledger data.

After receiving the input data at step 202, the method 200 can proceed to step 204. Step 204 can include selecting, from the input data, a data subset comprising one of either one or more credit records or one or more debit records. In other words, a system performing the method 200 will select from the input data a subset (one or more) of credit records from the input data or a subset (one or more) of debit records from the input data at step 204. A system performing the method 200 may determine prior to or during selection of the data subset that the selected data subset comprises either debit or credit records based on a label/flag associated with the data subset, based on a location in the input data from which the data subset is selected (e.g., a debit column or a credit column in general ledger data), based on whether the records in the selected data subset are positive negative values, or any other conceivable manner for discriminating between debit and credit records in the input data.

In accordance with selecting a data subset of debit records at step 204, the method 200 may proceed to step 206a. Step 206a can include generating an identifier associated with the first data subset of debit records. The identifier can be generated using a hash function applied to the selected data subset of debit records. In some examples, the identifier can be an absolute value of the combination of debit records (i.e., the absolute value of the sum of each of the debit records in the selected subset) included in the selected data subset. The identifier may be a hash of a sum of the debit records in the debit subset (or credit records in the credit subset if a credit subset is selected). The identifier may be the sum of the debit records in the debit subset (or credit records in a credit subset if a credit subset is selected). The identifier may be an absolute value of the one or more debit records in the first subset of debit records (or credit records in a credit subset if a credit subset is selected). The identifier can indicate the amount of money that is relevant to the selection. For instance, if two credits are selected as a subset, and their amounts are $5.50 and $10.20, the identifier can be the sum of the selection, $15.70. This identifier can then be represented as an integer, a float, a decimal, or a combination of these data types.

After generating an identifier associated with the first data subset at step 206a, the method 200 can proceed to step 208a. Step 208a can include determining whether an identifier exists in a credit population that matches the identifier associated with the selected data subset of debit records generated at step 206a. Accordingly, at step 208a, a system performing the method 200 can compare the identifier generated at step 206a to identifiers in a data structure associated with one or more data subsets of credit records selected from the same journal entry in the first input data.

If no identifier exists in a credit population that matches the identifier associated with the selected data subset of debit records generated at step 206a, then the method 200 can proceed to step 210a. Step 210a can include adding the selected subset of debit records to a data structure that includes a debit population. In some examples, the data structure that includes the debit population (e.g., subsets of debit records from a respective journal entry) can be a hash table. A hash table is data structure that maps keys to values and allows for efficient lookup and comparison of data stored in the hash table. As noted above with reference to FIG. 1, the data structure may alternatively be a hash set, a b-tree, a sorted array, an unsorted array, or other data structure that allows for efficient lookup and comparison of data stored in the data structure.

After adding the selected subset of debit records to a debit population of a data structure at step 210a, the method 200 can proceed to step 218. Step 218 can include determining whether there are any remaining data subsets of either debit or credit records in the respective journal entry. If there are subsets remaining in the journal entry, the method 200 can proceed back to step 204 and select one of the remaining subsets from the input data. If there are no remaining subsets, then the method 200 can proceed to step 220. Step 220 can include generating an output. An output may be generated at various alternative or additional steps during the method 200 (e.g., an output may be generated that includes an indication of a sub-journal entry at step 212). The outputs may include indications of anomalous journal entries and/or sub-journal entries. The indications of anomalous journal entries or sub-journal entries can include an indication of misstatements or high-risk transactions. The output may include any one or more of the following: indications of inefficiencies in business operations, indications of errors in financial reporting, duplication of financial transactions, identification and grouping of similar transactions, indications distinguishing between financial events booked together, identifications of applicable offsets to transactions, and/or assessments of the validity of offsets to a transaction. After generating an output at step 220, the method 200 may end.

Alternatively, in accordance with selecting a data subset of credit records at step 204, the method 200 may proceed to step 206b. Step 206b can include generating an identifier associated with the data subset of credit records. The identifier may be any of those described above at step 206a. As such, the identifier can likewise be generated using a hash function. In some examples, the identifier can include an absolute value of the combination of credit records (i.e., the absolute value of the sum of each of the credit records in the selected subset) included in the selected data subset.

After generating an identifier associated with the data subset of credit records at step 206b, the method 200 can proceed to step 208b. Step 208b can include determining whether an existing identifier exists in a debit population that matches the identifier associated with the selected data subset of credit records generated at step 206b. Accordingly, at step 208b, a system performing the method 200 can compare the identifier generated at step 206b to identifiers in a data structure associated with one or more data subsets of debit records selected from the same journal entry in the input data.

If no identifier exists in a debit population that matches the identifier associated with the selected data subset of credit records generated at step 206b, then the method 200 can proceed to step 210b. Step 210b can include adding the selected subset of credit records to data structure that includes a credit population. In some examples, the data structure that includes the credit population (e.g., subsets of credit records from a respective journal entry) can be a hash table. As noted above with reference to FIG. 1, the data structure may alternatively be a hash set, a b-tree, a sorted array, an unsorted array, or other data structure that allows for efficient lookup and comparison of data stored in the data structure.

After adding the selected subset of credit records to a data structure that includes a credit population at step 210b, the method 200 can proceed to step 218. As noted above, step 218 can include determining whether there are any remaining data subsets of either debit or credit records in the respective journal entry in the input data. If there are subsets remaining in the journal entry, the method 200 can proceed back to step 204 and select one of the remaining subsets from the journal entry in the input data. If there are no remaining subsets, then the method 200 can proceed to step 220, wherein step 220 includes generating an output, for instance, including any of the outputs described above. After generating an output at step 220, the method 200 can end.

In accordance with identifying an existing identifier in a data structure that includes a credit population that matches the identifier associated with the selected data subset of debit records generated at step 206a, or in accordance with identifying an existing identifier in a data structure that includes a debit population that matches the identifier associated with the selected data subset of credit records generated at step 206b, the method can proceed to step 212. Step 212 can include recording the matching subset of debit records and credit records as a sub-journal entry. The sub-journal entry can be stored by a system performing the method 200 in a data log, for instance, one or more of the databases 112 of system 100.

After recording the matching subset of debit records and credit records as a sub-journal entry at step 212, the method 200 can proceed to step 214. Step 214 can include removing, from a first data structure, one or more data subsets of debit records that include the debit records contained in the matching subset identified at step 208a or 208b. The data structure from which the one or more data subsets of debit records are removed at step 214 is the same data structure to which subsets of debit records are added at step 210a. Thus, the data structure is progressively populated with subsets of debit records for which matching subsets of credit records in a separate data structure are not identified and progressively depopulated by removing subsets that include debit records found in matching subsets during parsing of a journal entry.

As such, at step 214, a system performing the method 200 may identify one or more subsets of debit records that include debit records from the first sub-journal entry in a first data structure. The system performing the method 200 may further be configured to remove the identified one or more subsets of debit records from the respective data structure. In some examples, all subsets of debit records including debit records from the first sub-journal entry may be removed from the respective data structure. The first data structure including one or more data subsets of debit records may be a hash table, a hash set, a b-tree, a sorted array, or an unsorted array, or any other suitable data structure. The data structure from which the one or more data subsets of debit records are removed at step 214 does not include subsets of credit records.

After removing one or more data subsets of debit records that include debit records contained in the matching subset (e.g., the fist sub-journal entry) from a first data structure at step 214, the method 200 can proceed to step 216. Step 216 can include removing, from a second data structure, one or more subsets of credit records that include the credit records contained in the matching subset identified at step 208a or 208b. The data structure from which the one or more data subsets of credit records are removed at step 216 is the same data structure to which subsets of credit records are added at step 210b. Thus, the data structure is progressively populated with subsets of credit records for which matching subsets of debit records in a separate data structure are not identified and progressively depopulated by removing subsets that include credit records found in matching subsets during parsing of a journal entry.

As such, at step 216, a system performing the method 200 may identify one or more subsets of credit records that include credit records from the first sub-journal entry in a second data structure. The system performing the method 200 may further be configured to remove the identified one or more subsets of credit records from the respective data structure. In some examples, all subsets of records that include credit records from the first sub-journal entry may be removed from the second data structure. The data structure including one or more data subsets of credit records may be a hash table, a hash set, a b-tree, a sorted array, or an unsorted array, or any other suitable data structure. Steps 214 and 216 as described above can be performed sequentially, simultaneously, or in a different order.

After removing subsets of debit records from a first data structure at step 214 and removing subsets of credit records from a second data structure at step 216, the method 200 may proceed to step 218. Step 218 can include determining whether there are any remaining data subsets of either debit or credit records in the respective journal entry. If there are subsets remaining in the journal entry, the method 200 can proceed back to step 204 and select one of the remaining subsets from the input data. If there are no remaining subsets, then the method 200 can proceed to step 220. Step 220 can include generating, by one or more processors performing the method 200, an output. As noted above, an output may be generated at various alternative or additional steps during the method 200 (e.g., an output may be generated that includes an indication of a sub-journal entry at step 212). After generating an output at step 220, the method 200 may end.

As described above, existing approaches for parsing large journal entries in financial reporting often rely on either obtaining information about the journal entries (e.g., which credit and debit records form a single journal entry) from the auditee or “brute force” computation of every possible combination until a combination that foots to zero is found. Such brute forcing computation methods can become computationally unworkable as the number of possible combinations grows exponentially with the number of line items in a journal entry. The possible combinations of a journal entry are as follows where n is equal to the number of lines in a journal entry.

$${\sum }_{k = 2}^{n} \frac{n !}{k ! ( n - k ) !}$$

A journal entry with 30 lines can pose over a billion different combinations, as shown below in Table 1.

TABLE 1
Escalation of Combinations According to Journal Entry Size.

| Journal | Possible |
|---|---|
| Entry Size | Combinations |
| 10 | 1,013 |
| 20 | 1,048,555 |
| 30 | 1,073,741,793 |

The systems and methods for parsing journal entries disclosed herein reduce the number of possible combinations by separating debit and credit combinations/subsets into distinct hash tables, identifying matching subsets of debit records and credit records within a journal entry (e.g., subsets that foot to zero), as described above, and by removing debit and credit records from consideration that are included in the matching subsets.

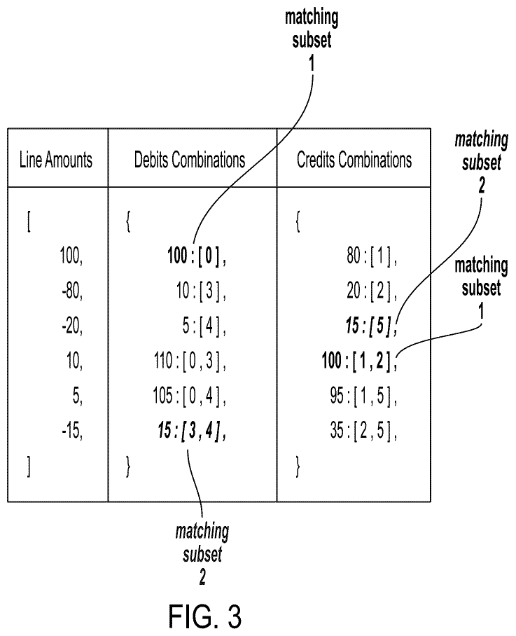

FIG. 3 illustrates an exemplary data structure including a first hash table that includes debit combinations (i.e., subsets of debit records) and a second hash table that includes credit combinations (i.e., subsets of credit records). Each of the respective hash tables can be generated according to known methods for generating a hash table. Each of the respective hash tables, as shown in FIG. 3, can include a plurality of subsets of records (debit records in the debit hash table and credit records in the credit hash table, as shown). The subsets of records can each be represented in the respective hash tables by one or more line-item numbers associated with each record in the subset and an identifier, the identifier being an absolute value of the respective subset of records. For instance, line-item zero is a debit record subset (comprising only one debit record) and is associated with an identifier “100,” wherein 100 represents the absolute value of the debit record subset. The line amounts column in the example depicted in FIG. 3 represents the dollar impact of the individual lines from an accounting standpoint.

As described above with reference to the system 100 of FIG. 1 and the method 200 of FIG. 2, when an identifier associated with a debit or credit record subset is identified as matching an identifier in associated with a credit or debit record subset, respectively, all subsets/combinations including those debit and credit records are removed from the respective hash tables. For instance, as shown in FIG. 3, the lines 0, 1, and 2 are a matching journal entry formed of a subset of debit records and credit records stored in the two respective hash tables, the match being indicated by the matching identifier “100” associated with debit record line “0” and credit record lines “1” and “2.” A system performing the journal entry parsing methods described herein would, upon determining this match, remove all subsets of credit and debit records including any of lines 0, 1, and 2 from the respective hash tables (e.g., the first, fourth, and fifth entries in the debit hash table and the first, second, fourth, fifth, and sixth entries from the credit hash table).

Similarly, lines 3, 4, and 5 form a matching journal entry combination, as indicated by the matching identifier “15,” which is the absolute value of the sum of debit record lines 3 and 4 and the absolute value of credit record line 5. As such, a system performing the journal entry parsing methods described herein would, upon determining this match, remove all subsets of credit and debit records including any of lines 3, 4, and 5 from the respective hash tables.

In following equation where d is the number of debit lines and c is the number of credit lines in the journal entry, the number of possible combinations for journal entries of various sizes according to a best- and worst-case scenario using the systems and methods disclosed herein can be computed:

$${\sum }_{k = 1}^{d} \frac{d !}{k ! ( d - k ) !} + {\sum }_{j = 1}^{c} \frac{c !}{j ! ( c - j ) !}$$

The resulting best- and worst-case scenarios for journal entries of various sizes using the systems and methods disclosed herein computed using the equation above are shown below in Table 2.

| Journal | Possible | | |
|---|---|---|---|
| Entry Size | Combinations | Best Case | Worst Case |
| 10 | 1013 | 62 | 512 |
| 20 | 1,048,555 | 2,046 | 524,288 |
| 30 | 1,073,741,793 | 65,534 | 536,870,912 |

The “best- and worst-case scenarios” are dependent on the number of lines of debits and credits relative to one another. In other words, if there are an equal number of debits and credits, fewer possible combinations are present than if the journal entry has more debits than credits, or vice versa. For instance, a 40-line entry with 20 debits (1 million possible combinations) and 20 credits (1 million possible combinations) would have around 2 million possible combinations to check. However, a 40-line entry with 30 debits (1 billion possible combinations) and 10 credits (1 thousand possible combinations) would have around 1 billion possible combinations to check.

By removing subsets of credit and debit records including credit and debit records/lines associated with identified matching journal entry combinations, the number of possible combinations (e.g., as shown above in Table 1) quickly collapses to a more computationally manageable number, for instance, as shown below in Table 3.

| Journal | | | | |
|---|---|---|---|---|
| Entry | Removed | Possible | | |
| Size | Lines | Combinations | Best Case | Worst Case |
| 30 | 0 | 1,073,741,793 | 65,534 | 536,870,912 |
| 30 | 2 | 268,435,427 | 32,766 | 134,217,728 |
| 30 | 4 | 67,108,837 | 16,382 | 33,554,432 |
| 30 | 8 | 4,194,281 | 4094 | 2,097,152 |
| 30 | 16 | 16,369 | 254 | 8,192 |

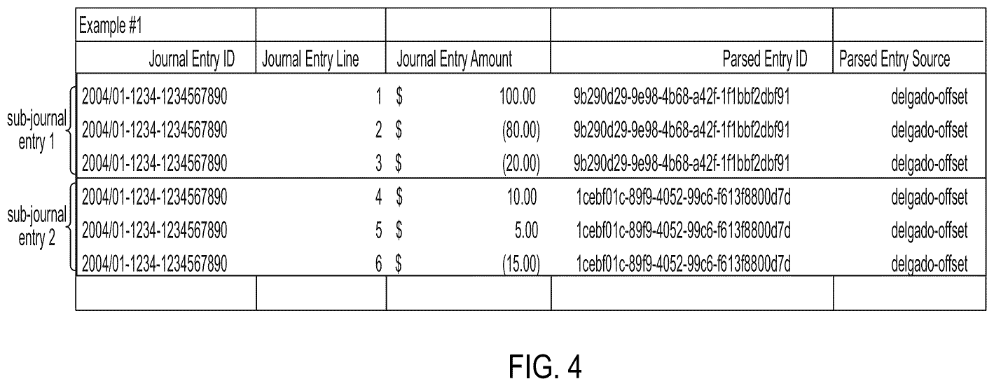

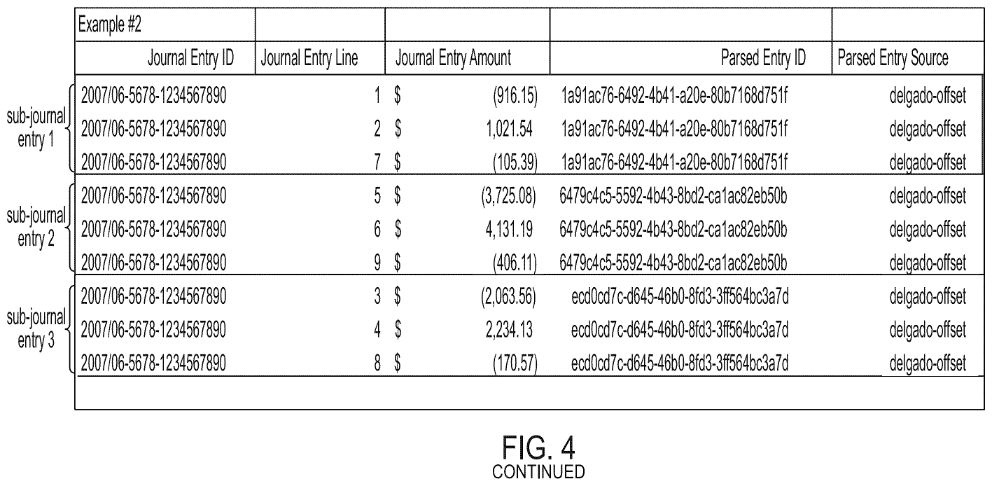

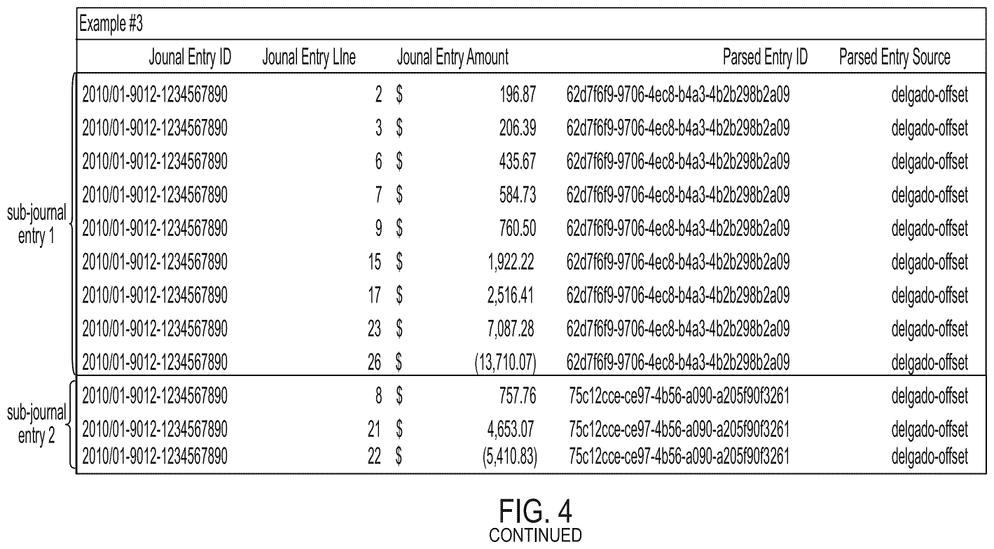

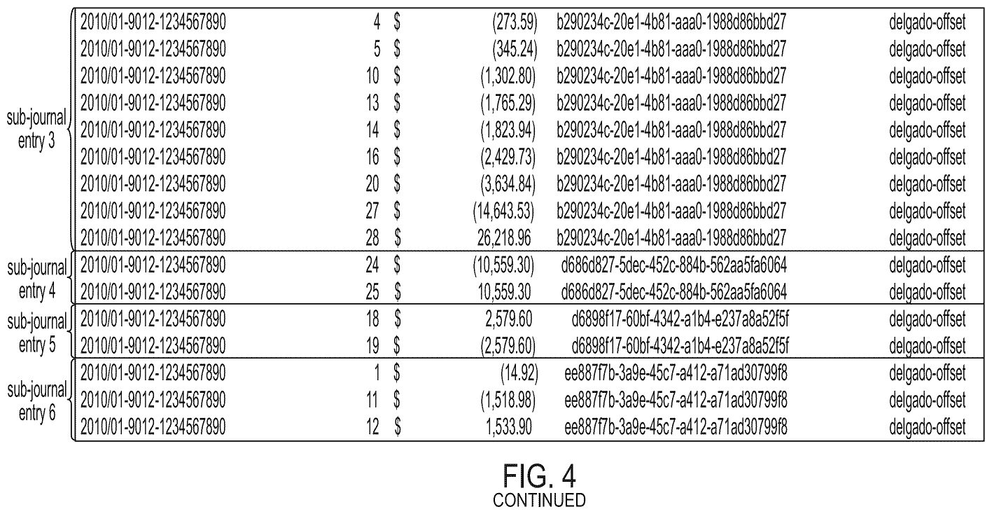

FIG. 4 illustrates exemplary generated outputs of the systems and methods described herein according to some embodiments. As shown, FIG. 4 includes three exemplary outputs (Example #1, Example #2, and Example #3), and each of the outputs are associated with a respective journal entry. The journal entry associated with Example #1 includes six line-items (i.e., a total of six credit or debit records), the journal entry associated with Example #2 includes nine line-items, and the journal entry associated with Example #3 includes 28 total line-items. The exemplary output shown in each of Example #1, Example #2, and Example #3 demonstrates how the systems and methods disclosed herein can successfully parse journal entries of various sizes into groups of sub-journal entries. For instance, the twenty-eight line-items of the parsed journal entry depicted in Example #3 of FIG. 4 are shown parsed into six sub-journal entries of varying numbers of credit and debit records. Similarly, the six line-items of Example #1 are shown parsed into two sub-journal entries and the nine line items of Example #2 are shown parsed into three sub-journal entries.

As described above, the outputs generated by the systems and methods described herein may also include indications of anomalous journal entries and/or sub-journal entries. The indications of anomalous journal entries or sub-journal entries can include an indication of misstatements or high-risk transactions. The generated outputs may include any one or more of the following: indications of inefficiencies in business operations, indications of errors in financial reporting, duplication of financial transactions, identification and grouping of similar transactions, indications distinguishing between financial events booked together, identifications of applicable offsets to transactions, and/or assessments of the validity of offsets to a transaction.

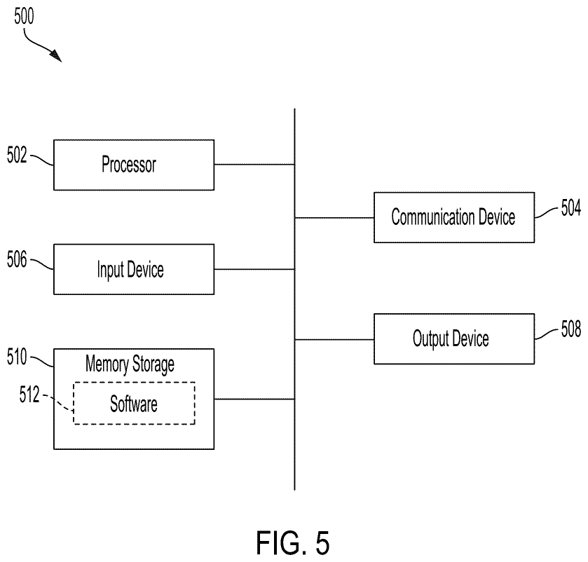

FIG. 5 depicts an exemplary computing device 500, in accordance with one or more examples of the disclosure. Device 500 can be a host computer connected to a network. Device 500 can be a client computer or a server. As shown in FIG. 5, device 500 can be any suitable type of microprocessor-based device, such as a personal computer, workstation, server, or handheld computing device (portable electronic device) such as a phone or tablet. The device can include, for example, one or more of processors 502, input device 506, output device 508, storage 510, and communication device 504. Input device 506 and output device 508 can generally correspond to those described above and can either be connectable or integrated with the computer.

Input device 506 can be any suitable device that provides input, such as a touch screen, keyboard or keypad, mouse, or voice-recognition device. Output device 508 can be any suitable device that provides output, such as a touch screen, haptics device, or speaker.

Storage 510 can be any suitable device that provides storage, such as an electrical, magnetic, or optical memory, including a RAM, cache, hard drive, or removable storage disk. Communication device 504 can include any suitable device capable of transmitting and receiving signals over a network, such as a network interface chip or device. The components of the computer can be connected in any suitable manner, such as via a physical bus or wirelessly.

Software 512, which can be stored in storage 510 and executed by processor 502, can include, for example, the programming that embodies the functionality of the present disclosure (e.g., as embodied in the devices as described above).

Software 512 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 510, that can contain or store programming for use by or in connection with an instruction execution system, apparatus, or device.

Software 512 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 500 can implement any operating system suitable for operating on the network. Software 512 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for parsing journal entries comprising:
receiving input data comprising a plurality of journal entries from one or more data sources; and
parsing a first journal entry of the plurality of journal entries, wherein parsing the first journal entry comprises:
(a) selecting a first subset of records from a first journal entry of the plurality of journal entries, the first subset of records comprising either one or more debit records or one or more credit records;
(b) determining that an identifier associated with the first subset of records matches an identifier associated with a second subset of records, the second subset of records comprising one or more credit records if the first subset of records comprises one or more debit records and the second subset of records comprising one or more debit records if the first subset of records comprises one or more credit records; and
(c) in accordance with determining that the identifier associated with the first subset of records matches the identifier associated with the second subset of records, recording the first subset of records and second subset of records as a first sub-journal entry.

2. The method of claim 1, further comprising in accordance with determining that additional subsets of records remain in the first journal entry, repeating steps (a) through (c).

3. The method of claim 1, wherein parsing the first journal entry further comprises: in accordance with determining that the identifier associated with the first subset of records matches the identifier associated with the second subset of records:
identifying one or more subsets of records comprising debit records in the first sub-journal entry in a first data structure; and
removing the identified one or more subsets of records from the first data structure.

4. The method of claim 1, wherein parsing the first journal entry further comprises: in accordance with determining that the identifier associated with the first subset of records matches the identifier associated with the second subset of records:
identifying one or more subsets of records comprising credit records in the first sub-journal entry in a second data structure; and
removing the identified one or more subsets of records from the second data structure.

5. The method of claim 3, wherein the first data structure comprises a first hash table comprising one or more subsets of debit records from the first journal entry, and wherein the first hash table does not include credit records.

6. The method of claim 4, wherein the second data structure comprises a second hash table comprising one or more subsets of credit records from the first journal entry, and wherein the second hash table does not include debit records.

7. The method of claim 1, wherein parsing the first journal entry further comprises: in accordance with determining that an identifier associated with the first subset of records does not match an identifier associated with a second subset of records, adding the first subset of records to the first data structure if the first subset of records comprises debit records and adding the first subset of records to the second data structure if the first subset of records comprises credit records.

8. The method of claim 1, wherein the input data comprises general ledger data.

9. The method of claim 1, further comprising: generating an output, the output comprising an indication of the debit records and credit records forming the sub-journal entry.

10. The method of claim 9, wherein the output comprises any one or more of: an indication of a misstatement, an indication of a high-risk transaction, indications of inefficiencies in business operations, indications of errors in financial reporting, duplication of financial transactions, identification and grouping of similar transactions, indications distinguishing between financial events booked together, identifications of applicable offsets to transactions, and assessments of the validity of offsets to a transaction.

11. The method of claim 1, wherein the first and second identifier are generated using a hash function.

12. The method of claim 1, wherein the first identifier comprises an absolute value of the first subset of records and the second identifier comprises an absolute value of the second subset of records.

13. A system for parsing journal entries, the system comprising one or more processors configured to cause the system to:
receive input data comprising a plurality of journal entries from one or more data sources; and
parse a first journal entry of the plurality of journal entries, wherein parsing the first journal entry comprises:
(a) selecting a first subset of records from a first journal entry of the plurality of journal entries, the first subset of records comprising either one or more debit records or one or more credit records;
(b) determining that an identifier associated with the first subset of records matches an identifier associated with a second subset of records, the second subset of records comprising one or more credit records if the first subset of records comprises one or more debit records and the second subset of records comprising one or more debit records if the first subset of records comprises one or more credit records; and
(c) in accordance with determining that the identifier associated with the first subset of records matches the identifier associated with the second subset of records, recording the first subset of records and second subset of records as a first sub-journal entry.

14. A non-transitory computer readable storage medium storing one or more programs for parsing journal entries, the one or more programs configured to be executed by one or more processors of an electronic device that when executed by the device cause the device to:
receive input data comprising a plurality of journal entries from one or more data sources; and
parse a first journal entry of the plurality of journal entries, wherein parsing the first journal entry comprises:
(a) selecting a first subset of records from a first journal entry of the plurality of journal entries, the first subset of records comprising either one or more debit records or one or more credit records;
(b) determining that an identifier associated with the first subset of records matches an identifier associated with a second subset of records, the second subset of records comprising one or more credit records if the first subset of records comprises one or more debit records and the second subset of records comprising one or more debit records if the first subset of records comprises one or more credit records; and
(c) in accordance with determining that the identifier associated with the first subset of records matches the identifier associated with the second subset of records, recording the first subset of records and second subset of records as a first sub-journal entry.
